(19) United States
(12) Patent Application Publication
(10) Pub. No.: US 2002/0106931 A1
(43) Pub. Date: Aug. 8, 2002

(54) Moisture-resistant flexible strand lighting apparatus

(76) Inventor: Chen Hsien-Te, Shanghai (CN)

Correspondence Address: Carl M. Davis II, Baker, Donelson, Bearman & Caldwell, Suite 900, Five Concourse Parkway, Atlanta, GA, 30328, US

(21) Appl. No.: 09/736,764

(22) Filed: Dec. 12, 2000

(51) Int. Cl. F21V 31/00; H01R 3/00

(52) U.S. Cl. 439/490; 362/249

(57) ABSTRACT

A flexible strand lighting apparatus (10) for ornamental illumination particularly in environments subject to moisture, with a power cord (12) that connects to a supply of electrical current and a moisture-resistant connector (30) with a pair of members (42, 44) at an opposing distal end in electrical communication with the electrical connectors. A tubular light strand (14) has two electrical conductors (54, 56) that connect in series to a plurality of spaced-apart light sources (52). A second moisture-resistant connector (58) is molded to and integral with the light strand (50) and includes a pair of second members (64, 66), which matingly engage with the members (42, 44) of the first connector (30) when the first and the second connectors join together in a moisture-resistant connection for communicating electrical current to the light sources (50).

### TECHNICAL FIELD

The present invention relates to lighting devices. More particularly, the present invention relates to lighting apparatus having a plurality of bulbs spaced-apart within a flexible strand particularly useful for wet locations illumination and lighting effects.

### BACKGROUND OF THE INVENTION

Lighting fixtures are increasingly being used for ornamental and lighting effects with buildings, roadways, and landscaping. Lighting devices that are provided for ornamental effects include a connector to a source of electrical current, a plurality of lighting fixtures with lamps or other bulbs which emit light from the fixtures, and wiring that connects the fixtures to the supply of electrical current. The supply of electricity may be high voltage (120 volt, alternating current) or low voltage (12 volt, direct current). Generally, the low voltage lighting systems are more easily installed, as compared to high voltage systems. These low voltage systems typically operate with transformers which connect to a supply of high voltage. The transformers convert the voltage to direct current which is communicated through the wires to the light bulbs. Low voltage lighting systems provide a number of advantages. Because the current is low voltage, the electrical connections of the wiring do not require special electric junction boxes. Special conduit is generally not required for the wiring, and the wiring may be exposed. Preferably the wiring is placed away from traffic areas or buried underground without conduits. Low voltage lights generate little heat and so are appropriate for use mounted to wooden surfaces.

While the low voltage lighting systems provide illuminative effects, the brightness of the lighting has not been entirely satisfactory. Generally, the lights are limited in wattage, typically commercially to about 20 watts per bulb. Also, the use of transformers is not entirely satisfactory. Transformers are subject to radio frequency interference (RFI) which may cause the lights to flicker or dim. Transformers are generally bulky and often require special mounting. The total combined wattage of the lamps operated by the transformer cannot exceed the output of the transformer. Nor do the transformers deliver the full rated wattage to the lamps. As the distance increases between the lamp and the transformer, the lumen output decreases.

In contrast, lighting systems with high voltage 120 volt alternating current generally do not limit the number of lamps used in the application. Lumen output from the lamps remains substantially constant independent of the length of the wires. The lamps receive full wattage capacity. These systems, however, require insulatedjunction boxes to make electrical connections and the wiring passes through insulated conduit.

One illuminative lighting apparatus is known as rope lighting or “cord” lights. The term “rope lighting” refers to the rope-like, flexible strand or cord appearance and handling characteristics of the lighting apparatus. This type of lighting apparatus consists of a translucent or transparent elongate flexible cord which encloses a plurality of spaced-apart low wattage bulbs. The cord includes a pair of electrical conductors for communicating electricity from a source to the light bulbs in series. The cord is approximately one half inch in diameter and is readily attached with clips to outdoor banisters, rails, steps, decking and the like, and indoors as well. Some types of awnings have open slots which grippingly receive the elongate cord. The flexible rope lighting is provided in an elongated length which is cut to length at predetermined intervals. End caps are placed on the cut ends to close the cord. Several lengths of the cord may be joined together as a continuous lighting strand. Adjacent cut ends link together with tubular connectors. One end connects to a source of electricity.

While rope lighting provides illuminative effects for buildings, driveways, walkways, and landscaping, there are drawbacks to its use. The cut ends of the cord lighting in combination with the end caps are difficult to make waterproof. Because these rope lights use non-shunting bulbs, when one bulb burns out, a section of a plurality of bulbs burn out. In response, the burned-out section is cut away and a new section inserted with the connectors. However, this makes a potentially dangerous electrical connection in that the connections of adjacent cut ends, as described above, are difficult to make waterproof.

Accordingly, there is a need in the art for an improved flexible strand lighting apparatus resistant to moisture penetration of connections. It is to such that the present invention is directed.

### BRIEF SUMMARY OF THE PRESENT INVENTION

The present invention meets the need in the art by providing a flexible strand lighting apparatus for ornamental illumination particularly in environments subject to moisture, in which the light apparatus includes a power cord having electrical connectors at a first end for connecting to a supply of electrical current. A first moisture-resistant connector is molded to and integral with the power cord at an opposing distal end. The first connector includes a pair of members in electrical communication with the electrical connectors. A light strand has a tubular body with a core extending therethrough having two electrical conductors engaged in series to a plurality of spaced-apart light sources. A second moisture-resistant connector at a distal end of the light strand is molded to and integral with the light strand and includes a pair of second members in electrical communication with the electrical conductors. The second members are adapted for mating engagement with the members of the first connector. A first engaging member associated with the first connector of the power cord and a second engaging member associated with the second connector of the light strand provide for engaging the first and the second connectors in a moisture-resistant junction to place the second members in the second connector in electrical communication with the members in the power cord for communicating electrical current to the light sources. The first and second connectors, being joined together, restrict moisture penetration into the junction that communicates electrical current to the light sources.

Objects, advantages, and features of the present invention will become apparent upon a reading of the following detailed description, in conjunction with the drawings and the appended claims.

### BRIEF DESCRIPTION OF THE DRAWINGS

FIG. 1 is a perspective view of a rope lighting apparatus according to the present invention.

FIG. 2 is a perspective, partially cut-away view of a first connector with a molded cap partially cut away, for illustrating features of the rope lighting shown in FIG. 1.

FIG. 3 is a perspective, partially cut-away view of a second connector with a molded cap partially cut-away, for use with the rope lighting shown in FIG. 1.

FIG. 4 is a schematic view illustrating an embodiment of a single strand of lights used in the rope lighting shown in FIG. 1.

FIG. 5 is a schematic view illustrating the rope lighting apparatus shown in FIG. 1 with connection of several series strands of lights (shown in FIG. 4) in parallel for providing an illuminative ornamental effect.

### DETAILED DESCRIPTION OF THE PREFERRED EMBODIMENTS

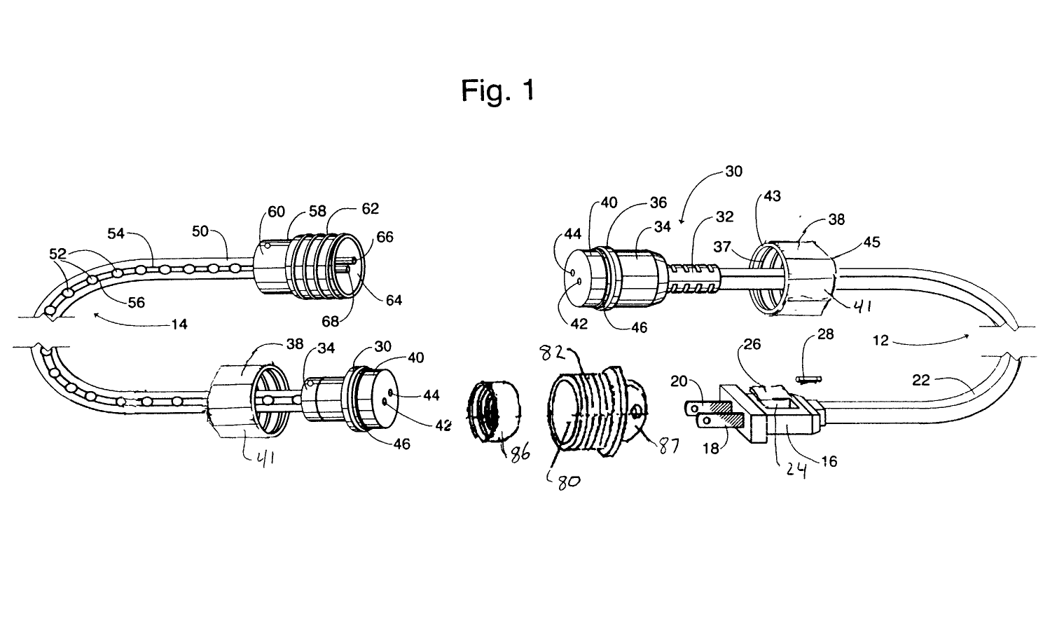

With reference to the drawings, in which like parts have like identifiers, FIG. 1 illustrates in perspective view a flexible strand lighting apparatus 10 according to the present invention. The lighting apparatus 10 includes a power cord generally 12 and at least one elongate light strand generally 14. The power cord 12 includes a plug 16 configured for matting engagement with a supply of high voltage, alternating current with a pair of electrical contact blades 18, 20 projecting from a distal end of the plug 16. Each blade 18, 20 connects to a electrically conductive wire carried in a cord 22. The parallel blade attachment plug 16 provides a connection to a conventional supply of electric current. The strain relief to the cord 22 is integral with the plug 16, as is conventional. In the illustrated embodiment, the plug 16 includes a fuse recess 24 which is closed by a cover 26. The fuse recess 24 receives a fuse 28 for providing current protection to the lighting apparatus 10. The fuse 28 in the illustrated embodiment is maximum 5 amp. The wire in the cord 22 is copper or copper alloy, stranded wire, 18 AWG minimum, in which the hot and neutral wires are spaced-apart a minimum of 3 millimeters.

An opposing distal end of the cord 22 terminates in a first connector 30. The first connector 30 includes a strain relief 32 which provides a transition between the main body 34 of the first connector 30 and the cord 22. A flange 36 projects radially outwardly from the main body 34 and defines a stop for a coupler 38 slidably received on the power cord 12, as discussed below. A shank 40 projects forwardly of the flange 36. The first connector 30 includes two sleeves 42, 44 which are electrically conductive and connected to the respective wires in the wire cord 22 for communicating with the parallel blades 18, 20. A gasket 46 is received on the shank 40 and seats against the flange 36. In the illustrated embodiment, the gasket 46 is molded of a low-density polyethylene foam to define an annular ring, with a 4 millimeter thickness, 1.3 centimeter inner diameter and 1.8 centimeter outer diameter. Preferably the gasket 46 is secured to the shank 40 by friction fit, such that the gasket stays in place during the disconnection of the connectors 30 and 58, as discussed below.

The coupler 38 is an open-ended body with an interior thread 37. In the illustrated embodiment, the coupler 38 defines an octagonal exterior with faces that define finger grips 41 thereon. The coupler 38 has a first open end 43 sized for slidingly being received on the connector 30 and extending past the flange 36. An opposing end 45 is of a smaller diameter to define a face that bears against the flange 36.

The light strand 14 includes an elongate transparent or translucent flexible tube or “rope” 50 that defines a rope-like flexible member. The rope 50 includes a plurality of spaced-apart bulbs 52 connected in series by electrical wires 54, 56. The bulbs 52 in the illustrated embodiment are of a type rated 5 volts, 0.05 amps, and 0.25 watts, and are preferably non-shunted. The bulbs 52 are spaced a minimum of 2.5 centimeters between bases. The wires 54, 56 are carried in a U-shaped core 51 (see FIG. 3). A first distal end of the rope 50 terminates in a second connector 58 having a main portion 60 and a threaded portion 62. The threaded portion 62 extends forwardly as an open-ended shroud 64 from an end wall of the main portion 60. Disposed within the shroud 64 are a pair of spaced-apart pins 66, 68. The outwardly distal end of the pins 66, 68 are flush with the distal end of the shroud 64. The pins 66, 68 electrically connect to the wires 54, 56 in the rope 50. The opposing distal end 76 of the light strand 14 terminates in another of the first connectors 30 which is as described above with respect to the power cord 12.

The light strand 14 is provided with an end cap 80 having a threaded exterior 82. A flange 87 extends from a back of the end cap 80. A cover 86 is sized for being received on the shank 40 of the connector 30 at the end of the light strand 14. The end cap 80 is sized for receiving the cover 86 in overlying relation on the shank 40 for engaging the threaded coupler 38 received on the rope 50. The end cap 80 thereby secures the cover 86 on the shank 40, closing the distal end of the light strand 14, while the cover 86 restricts moisture penetration to the electrical sleeves 42, 44.

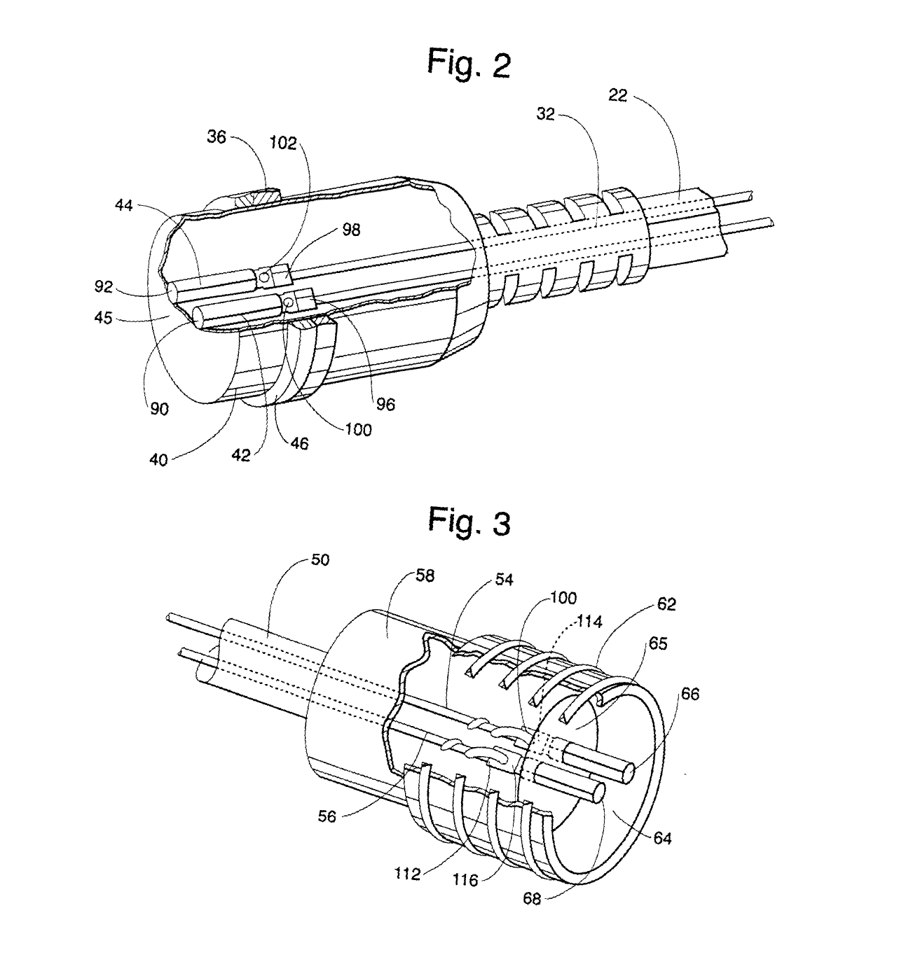

FIG. 2 is a perspective, partially cut-away view of the first connector 30 which is molded in place to the wire cord 22 (or to a distal end of the rope 50 as also used with the light strand 14). The connector 30 encloses the sleeves 42,44 which are open-ended cylinders. The respective distal ends 90, 92 of the sleeves 42, 44 are open and extend to the end wall 45 of the shank 40. An interior end of the sleeves 42, 44 are defined by clamps 96,98. The clamps 96,98 are defined by wing-like flanges that fold over to bear against a respective wire 54, 56 from the rope 50. The sleeves 42, 44 define holes 100, 102 between the clamp 96,98 and the distal ends 90,94. The distal end of the respective wires 54, 56 are received through the holes 100, 102 and soldered in place prior to the folding flaps of the clamps 96, 98 over the wire.

FIG. 3 is a perspective, partially cut-away view of the second connector 58 which defines a molded cap. The connector 58 is partially cut-away to illustrate features of the connector. The pins 66, 68 project forwardly from a wall 65. The portion 64 of the threaded end 62 defines a shroud which encloses the pins 66, 68. The interior diameter of the shroud is sized to receive the shank 40 of the connector 30. An interior end 110, 112 of the pins 66, 68 have flat plates with each defining a hole 114, 116. The wire 54, 56 carried in the rope 50 passes through the respective hole 114, 116, wraps over itself, and is soldered to the plates 110, 112 of the pins 66, 68. The wires 54, 56 in the cord 50 are carried in a core generally 51 having a U-shaped cross-section. The body of the connector 58 is preferably molded in place during manufacture, as discussed below.

The sleeves 42,44 preferably taper narrowingly from the open ends 90, 92 to the opposing end at the holes 100, 102, to facilitate gripping engagement with the pins 66, 68, as discussed below. The sleeves 42, 44 in the illustrated embodiment taper in diameter from 2.8 millimeter to 2.4 millimeter, with a sleeve length of 15.7 millimeters. The pins 66, 68 in the illustrated embodiment are cylindrical, having diameters of 2.5 millimeter and a length of 20 millimeters from a leading tip to an opposing distal end of the plate which plate has a longitudinal length of 5 millimeters. The holes 100, 102 in the sleeves 42, 44 and the holes 114, 116 and the pins 66, 68 have 1.7 millimeter diameters for receiving the electrical wires. Preferably, the electrical wires are #18 AWG minimum, type SPT-2 marked “W” or “WA”. The holes receive the #18 AWG wire therethrough, which is soldered to the respective sleeve or pin. The sleeves 42, 44 are spaced-apart 6 millimeters center-to-center of the sleeves. The shank 40 extends 10 millimeters from the flange 36 and has a diameter of 13 millimeters. The flange 36 extends radially to define an overall diameter of 17.8 millimeters.

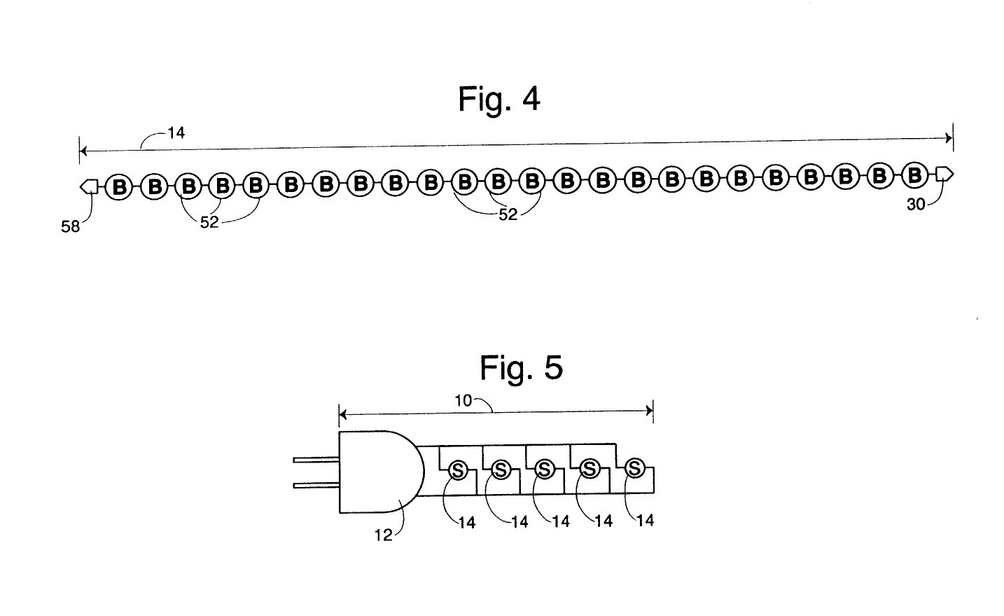

FIG. 4 is a schematic view illustrating the light strand 14 shown in FIG. 1. The bulbs 52 are connected in series to the wires 54, 56.

FIG. 5 is a schematic view illustrating parallel connection of five series strings of the light strands 14 and one of the power cord 12 to provide a length of lights that mount in wet locations for a lighting ornamental effect.

The Table 1 on the following page lists characteristics of several embodiments of the lighting apparatus 10, in which in the rating V is volts, A is amperes, and W is watts. The length of the apparatus is shown in feet. Each lighting strand 14 has twenty-four bulbs 52, spaced apart as indicated below in centimeters, with the total number of strands indicated. The input is 0.05 amps and 6 watts per twenty-four bulb series strand.

TABLE 1
FLEXIBLE LIGHTING APPARATUS

| | | Bulb Spacing | |
|---|---|---|---|
| Rating | length (ft) | (cm) | No. of Strands 14 |
| 120 V, 0.31 A, | 12 | 3.1 | 5 |
| 37.2 W | | | |
| 120 V, 0.46 A, | 18 | 2.8 | 8 |
| 55.2 W | | | |
| 120 V, 0.65 A, | 25 | 2.8 | 11 |
| 78 W | | | |
| 120 V, 1.3 A, | 50 | 2.8 | 22 |
| 156 W | | | |

With reference to FIG. 1, the power cord 12 is manufactured by cutting a wire cord 22 to length. The parallel blades 18, 20 connect conventionally to the wires in the cord 22. The plug 16 is preferably conventionally injection molded to secure the blades 18, 20 within the plug and to connect the body of the plug to the wire cord 22. The coupler 38 is received on the wire cord 22. With reference to FIG. 2, the sleeves 42, 44 are engaged to the wires in the wire cord 22. In the illustrated embodiment, the distal ends of the wires 54, 56 pass through the holes 100, 102 and are soldered to the sleeves 42, 44 to assure an electrical connection and a rigid physical connection between the sleeves and the wires. The flanges of the clamps 96, 98 are folded over onto the wire of the wire cord 22 to further secure the wire physically and in electrical communication with the sleeves 42, 44. The engaged sleeves 42, 44 and wires are held, and the body of the connector 30 is molded around the sleeves and the cord 22.

With reference to FIG. 1, the light strand 14 is manufactured. The wires 54, 56 are encased with plastic to preferably define the U-shaped channel 51. The bulbs 52 are soldered to the opposing wires 54, 56 in the channel 51 to provide the plurality of bulbs 52 connected in series. The assembly of the U-shaped channel 51 with the wires 54, 56 and the bulbs 52 is then encased in a larger plastic tube that is filled with a transparent, non-conductive plastic material to secure the bulbs 52 therein. The tube for the rope 50 is preferably QMFZ2 material manufactured by Georgia Gulf Chemicals & Vinyls LLC, type SP-7107, tube type construction, with an 11 millimeter outer diameter, a 3.5 millimeter inner diameter, and a nominal 3.75 millimeter wall thickness. With reference to FIGS. 2 and 3, the connectors 30 and 58 are then molded conventionally to the distal ends of the rope 50 to enclose the sleeves 42, 44 and the pins 66, 68, respectively.

A plurality of the light strands 14 may then be used together with one of the power cords 12 to provide ornamental lighting effects in wet locations, such as exterior decks, landscaping, and the like. The light strands 14 are not intended to be cut during installation and use of the lighting apparatus 10. With reference to FIG. 1, the gasket 46 is received on the shank 40 and seats against the flange 36. The connector 30 of the power cord 12 matingly engages the connector 58 of a first one of the light strands 14. The shank 40 is slidingly received in the shroud 64, with the pins 66, 68 being slidingly received in the sleeves 42, 44. The shroud 64 shields from inadvertent contact by the installer with the pins 66, 68 during assembly. The coupler 38 slides longitudinally pass the strain relief 32 and the main body 34 until stopped by the flange 36. The coupler 38 is rotated using the finger grips 41 to engage the thread 37 with the threaded end 62 of the connector 58. This secures the connector 30 of the power cord 12 to the connector 58 of the light strand 14. The coupler 38 and the threaded end 62 accordingly engage the power cord 12 and the light strand 14, while resisting moisture penetration to the electrical connection.

Additional light strands 14 can be connected. The connector 58 of the additional strand 14 is matingly engaged to the connector 30 of the adjacent previous light strand 14. This is accomplished by receiving the gasket 46 on the shank 40 and the shank slidingly received in the shroud 64 at the subsequent lighting strand 14. The coupler 38 on the first light strand 14 is rotated to engage the threaded end 62 of the connector 58 on the subsequent light strand 14. Additional light strands are similarly joined to the lighting assembly 10 by matingly engaging the connector 58 of a subsequent light strand to the connector 30 of the preceding light strand.

The light strand 14 in the assembly 10 distal from the power card 12 is closed by sliding the cover 86 over the shank 40 of the final light strand 14. The end cap 80 is then placed over the cover 86. The open face of the cap 80 bears against the gasket 46 and the flange 36 of the final connector 30. The coupler 38 on the final light strand 14 is rotated to engage the thread 37 with the thread 82 of the cap 80. The flange 87 can be gripped in order to facilitate rotating the coupler 38 into matting engagement with the end cap 80.

The present invention accordingly provides an improved wet location flexible strand lighting apparatus in which a plurality of low wattage bulb light strings are selectively joined to provide an extended rope mountable in wet locations for providing ornamental effect. Thermoplastic “U” clips with screws (not illustrated) may be used to mount the lighting apparatus 10, or nylon ties may be used. The lighting apparatus 10 is not intended to be cut-to-length during installation, whereby the electrical connections are secured and resist moisture penetration.

While this invention has been described in detail with particular reference to the preferred embodiments thereof, the principals and modes of operation of the present invention have been described in the foregoing specification. The invention is not to be construed as limited to the particular forms disclosed because these are regarded as illustrative rather than restrictive. Moreover, modifications, variations, and changes may be made by those skilled in the art without departure from the spirit and scope of the invention as described by the following claims.

What is claimed is:

1. A flexible strand lighting apparatus for providing ornamental illumination, comprising:
a power cord having a plug at a first end with a pair of electrical connectors projecting from the plug for connecting to a supply of electrical current and a first connector molded to an integral with the power cord at an opposing distal end, the first connector including a pair of members in electrical communication with the electrical connectors of the plug;
a light strand having a plurality of light sources connected in series to electrical wires carried in the light strand, a second connector at a distal end of the light strand molded to and integral with the light strand and including a pair of second members in electrical communication with the wires in the light strand, the second members adapted for mating engagement with the members of the first connector;
means for securing the first connector of the power cord to the second connector of the light strand, whereby the second members matingly connect to the members in the power cord for communicating electrical current;
whereby the plug, being in electrical communication with the a supply of electrical current, provides electricity to the light sources in the light strand.

2. The flexible strand lighting apparatus as recited in claim 1, wherein the light strand further comprises another of the first connectors at an opposing distal end of the light strand; and
a cap selectively attached to the first connector on the light strand for closing the distal end of the light strand from electrical communication thereat.

3. The flexible strand lighting apparatus as recited in claim 2, further comprising at least one second one of the light strands for mating engagement of the first and second connectors of two light strands, whereby the length of the flexible strand lighting apparatus is selectively changeable.

4. The flexible strand lighting apparatus as recited in claim 1, wherein the second members in the second connector comprise electrically conductive pins; and the members in the first connector comprise electrically conductive tubes sized for slidingly receiving the pins when the first and second connectors are engaged.

5. The flexible strand lighting apparatus as recited in claim 4, wherein the pins have diameters of about 2.5 millimeter.

6. The flexible strand lighting apparatus as recited in claim 5, wherein the sleeves taper narrowingly from open ends to opposing ends.

7. The flexible strand lighting apparatus as recited in claim 6, wherein the sleeves taper from about 2.8 millimeter to about 2.4 millimeter.

8. The flexible strand lighting apparatus as recited in claim 7, wherein the pins are spaced-apart about 6 millimeter center-to-center.

9. The flexible strand lighting apparatus as recited in claim 1, wherein the means for securing comprises:
the first connector defining a flange extending radially therefrom;
the power cord slidingly receives a threaded ring on the first connector and stopped by the flange; and
the second connector defines a threaded exterior for threadingly engaging the ring on the power cord for securing the first and second connectors together.

10. The flexible strand lighting apparatus as recited in claim 9, wherein the light strand further includes a second threaded ring for securing the first connector of the light strand to a second connector of a second one of said light strands.

11. The flexible strand lighting apparatus as recited in claim 1, further comprising a resilient ring received on the second connector to be disposed between the first and second connectors to seal the engagement thereof from moisture.

12. The flexible strand lighting apparatus as recited in claim 1, wherein a distal portion of the second connector extends as a shroud around the second members extended therein and the shroud receiving a distal end portion of the first connector when the first and second connectors matingly engage.

13. A flexible strand lighting apparatus for providing ornamental illumination particularly in environments subject to moisture, comprising:
a power cord having electrical connectors at a first end for connecting to a supply of electrical current and a first moisture-resistant connector molded to and integral with the power cord at an opposing distal end, the first connector including a pair of members in electrical communication with the electrical connectors;
a light strand having a tubular body with a core extending therethrough with two electrical conductors engaged in series to a plurality of spaced-apart light sources, a second moisture-resistant connector at a distal end of the light strand molded to and integral with the light strand and including a pair of second members in electrical communication with the electrical conductors and adapted for mating engagement with the members of the first connector;
a first engaging member associated with the first connector of the power cord and a second engaging member associated with the second connector of the light strand, for engaging the first and the second connectors in a moisture-resistant junction that places the second members in the second connector in electrical communication with the members in the power cord for communicating electrical current to the light sources,
whereby the joining of the first and second connectors restricts moisture penetration in the junction communicating electrical current to the light sources.

14. The flexible strand lighting apparatus as recited in claim 13, wherein the light strand further comprises another of the first connectors at an opposing distal end of the light strand; and
a cap selectively attached to the first connector on the light strand for closing the distal end of the light strand from electrical communication thereat.

15. The flexible strand lighting apparatus as recited in claim 13, further comprising at least one second one of the light strands for mating engagement of the first and second connectors of two light strands, whereby the length of the flexible strand lighting apparatus is selectively changeable.

16. The flexible strand lighting apparatus as recited in claim 13, wherein the members in the first connector comprise electrically conductive pins; and the second members in the second connector comprise electrically conductive tubes sized for slidingly receiving the pins when the first and second connectors are engaged.

17. The flexible strand lighting apparatus as recited in claim 13, wherein the pins have diameters of about 2.5 millimeter.

18. The flexible strand lighting apparatus as recited in claim 17, wherein the sleeves taper narrowingly from open ends to opposing ends.

19. The flexible strand lighting apparatus as recited in claim 18, wherein the sleeves from about 2.8 millimeter to about 2.4 millimeter.

20. The flexible strand lighting apparatus as recited in claim 17, wherein the pins are spaced-apart about 6 millimeter center-to-center.

21. The flexible strand lighting apparatus as recited in claim 13, wherein
the first connector defines a flange extending radially therefrom;
the first engaging member comprises a threaded ring slidingly received on the first connector on the power cord and stopped by the flange; and
the second engaging member comprises a threaded exterior on the second connector for threadingly engaging the ring on the power cord for securing the first and second connectors together.

22. The flexible strand lighting apparatus as recited in claim 21, wherein the light strand further includes a second threaded ring for securing the first connector of the light strand to a second connector of a second one of said light strands.

23. The flexible strand lighting apparatus as recited in claim 13, further comprising a resilient ring received on the second connector to be disposed between the first and second connectors to seal the engagement thereof from moisture.

24. The flexible strand lighting apparatus as recited in claim 13, wherein a distal portion of the first connector extends as a shroud around the second members.
